(19) United States
(12) Patent Application Publication
(10) Pub. No.: US 2026/0103431 A1
(43) Pub. Date: Apr. 16, 2026

(54) Worm Compost System

(71) Applicant: World Product Imports Pty Ltd, Mortdale (AU)

(72) Inventor: Richard David Low, Hurstville (AU)

(21) Appl. No.: 19/357,905

(22) Filed: Oct. 14, 2025

Related U.S. Application Data
(60) Provisional application No. 63/708,047, filed on Oct. 16, 2024.

(51) Int. Cl. C05F 17/95; C05F 17/05

(52) U.S. Cl. CPC C05F 17/955; C05F 17/05

(57) ABSTRACT

A worm compost system has a plurality of pairs of working trays, each working tray including an upwardly extending sidewall extending from a base to an upper perimeter to form an internal chamber. A lid assembly is positioned on a topmost pair of the working trays, and a harvest tray is removably attachable beneath a bottommost pair of the working trays, the harvest tray configured to collect processed compostable material. A movement mechanism including a set of bearings is disposed between nested trays of each pair of working trays, the bearings enabling relative rotational movement of the trays to facilitate passage of compostable material downward through the system.

### CROSS-REFERENCE TO RELATED APPLICATIONS

This application for a utility patent claims the benefit of U.S. Provisional Application No. 63/708,047, filed Oct. 16, 2024.

### BACKGROUND OF THE INVENTION

### Field of the Invention

This invention relates generally to composting, and more particularly to a worm composting system utilizing stacked trays.

### Description of Related Art

Traditional composting methods often rely on open piles, tumblers, or static bins. These approaches can be slow, difficult to manage, and prone to issues such as compaction of materials, poor aeration, and uneven decomposition. When compostable material is compressed, airflow decreases, leading to anaerobic conditions that create odor and hinder the breakdown of organic matter.

Worm composting systems, also known as vermicomposting systems, have been developed to accelerate decomposition and improve aeration by incorporating worms into the process. However, existing worm composting systems suffer from a number of shortcomings. Many prior designs use stacked bins or trays with perforated bottoms but these will either compress the material or create large air gaps between each tray. These systems typically require manual separation of worms and castings and become difficult to swap and manage when loaded with material.

Another drawback of conventional designs is limited airflow and ventilation, which can result in excessive moisture, lack of oxygen, and inconsistent worm castings. In addition, prior art systems may not provide adequate structural support to prevent trays from collapsing or compressing the compostable material. In prior art systems that do have structural support, those systems are limited due to large air gaps that form between trays which limits worm movement.

Accordingly, there remains a need for an improved worm compost system that allows continuous processing of compostable material through multiple levels, provides controlled ventilation, prevents compaction, and enables a simple method to facilitate downward passage of material between trays. The present invention fulfills these needs and provides further advantages as described in the following summary.

### SUMMARY OF THE INVENTION

The present invention teaches certain benefits in construction and use which give rise to the objectives described below.

The present invention provides a worm compost system comprising a plurality of pairs of working trays, each working tray including an upwardly extending sidewall extending from a base to an upper perimeter to form an internal chamber. A lid assembly is positioned on a topmost pair of the working trays, and a harvest tray is removably attachable beneath a bottommost pair of the working trays, the harvest tray configured to collect processed compostable material. A movement mechanism including a set of bearings is disposed between nested trays of each pair of working trays, the bearings enabling relative rotational movement of the trays to facilitate passage of compostable material downward through the system.

A primary objective of the present invention is to provide a worm compost system having advantages not taught by the prior art.

Another objective is to provide a worm compost system with a movement mechanism that allows relative rotation of nested trays to selectively permit compostable material to pass downward.

Another objective is to provide a worm compost system with ventilation features, including perforated lid portions and harvest tray ports, to improve airflow and reduce odor.

Another objective is to provide a worm compost system with a harvest tray that collects processed castings and leachate without requiring disassembly of the system.

A further objective is to provide a worm compost system that enables “self-harvesting” of compostable material in certain conditions, reducing the need for manual intervention.

Another objective is to prevent compaction of the substrate between trays while allowing material to form a contiguous body of material between trays.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

### The Accompanying Drawings Illustrate the Present Invention.

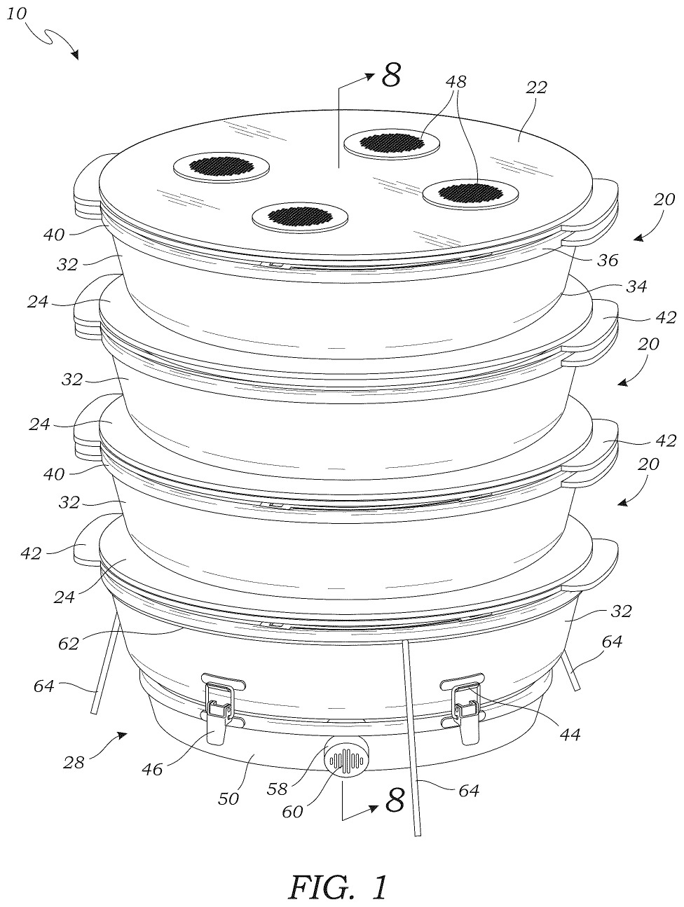

FIG. 1 is a perspective view of a worm compost system according to one embodiment of the present invention;

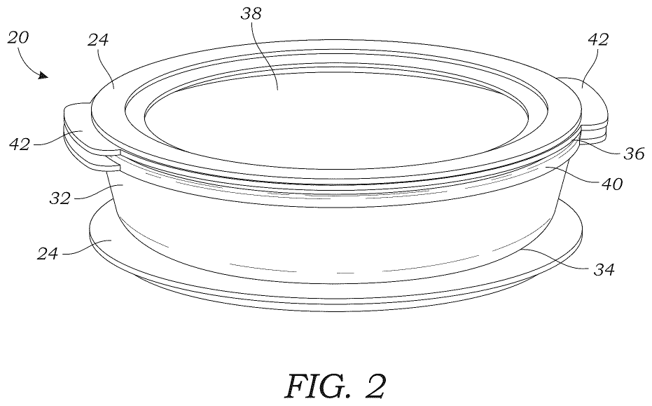

FIG. 2 is a perspective view of a pair of nested working trays having a stacking ring positioned on top of the pair of working trays, and another stacking ring positioned at the bottom of the pair of working trays;

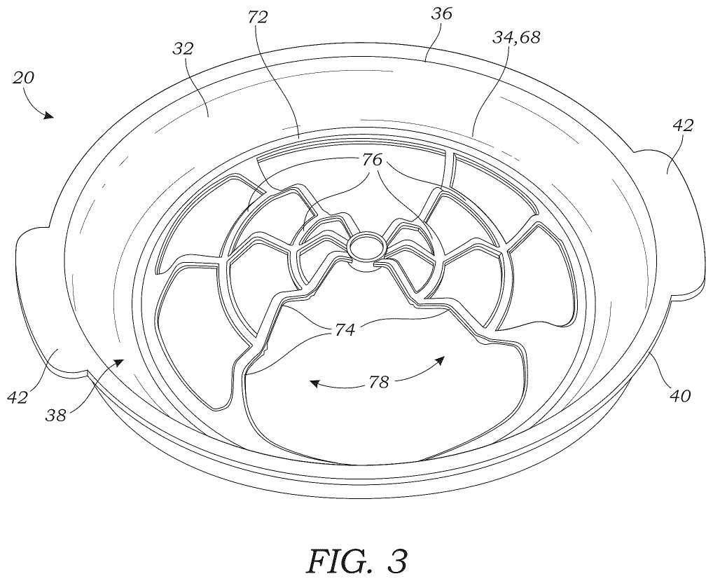

FIG. 3 is a top perspective view of a working tray showing a first lattice base;

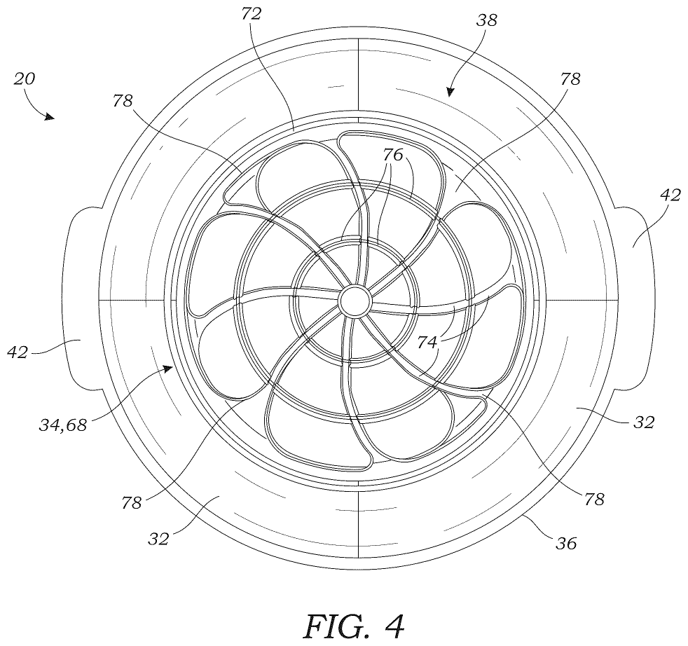

FIG. 4 is a top plan view of a pair of nested working trays, shown with the first lattice bases in a closed configuration;

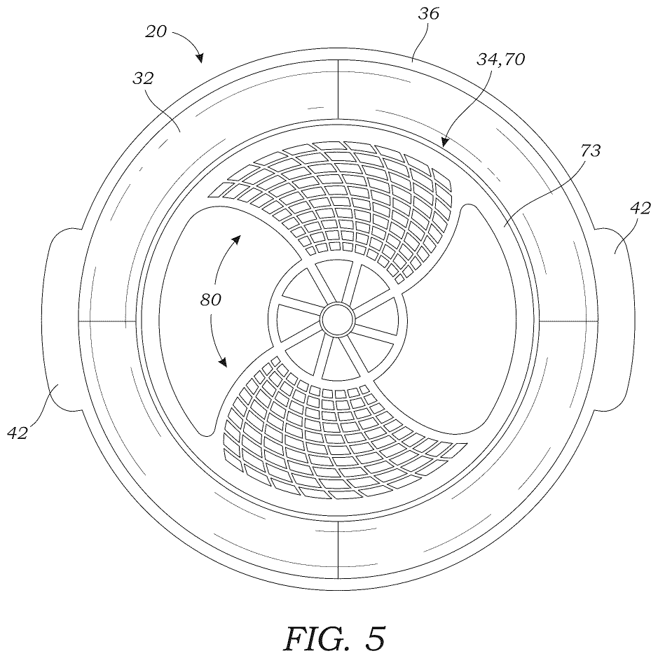

FIG. 5 is a top plan view of a working tray showing a second lattice base;

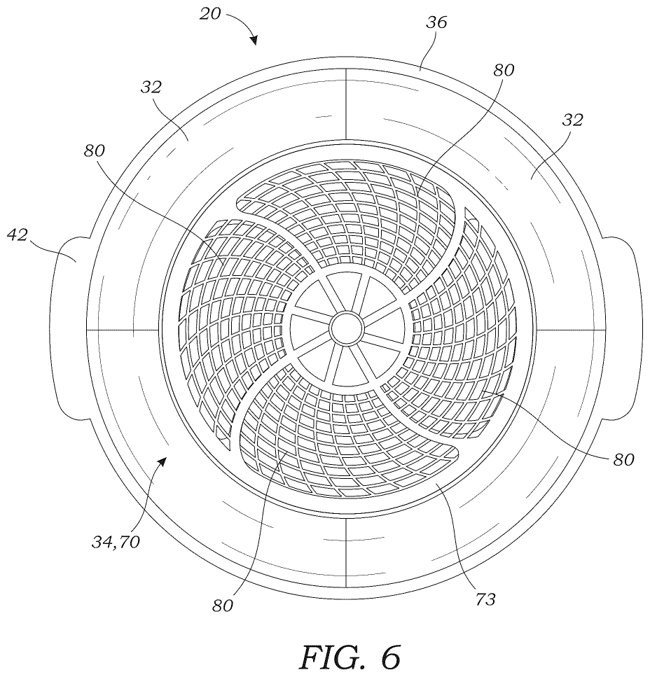

FIG. 6 is a top plan view of a pair of working trays, shown with the second lattice bases in a closed configuration;

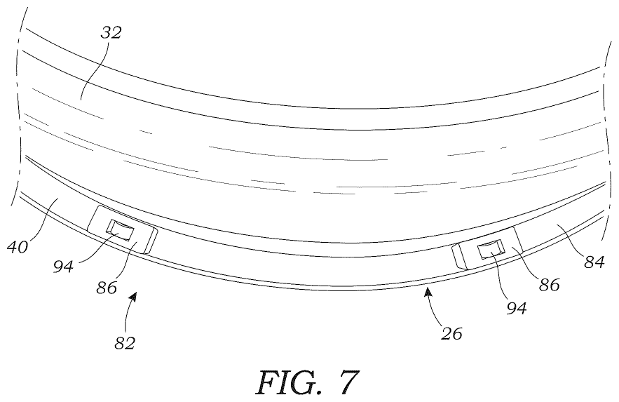

FIG. 7 is a bottom perspective view of a movement mechanism including a set of bearings disposed between nested working trays;

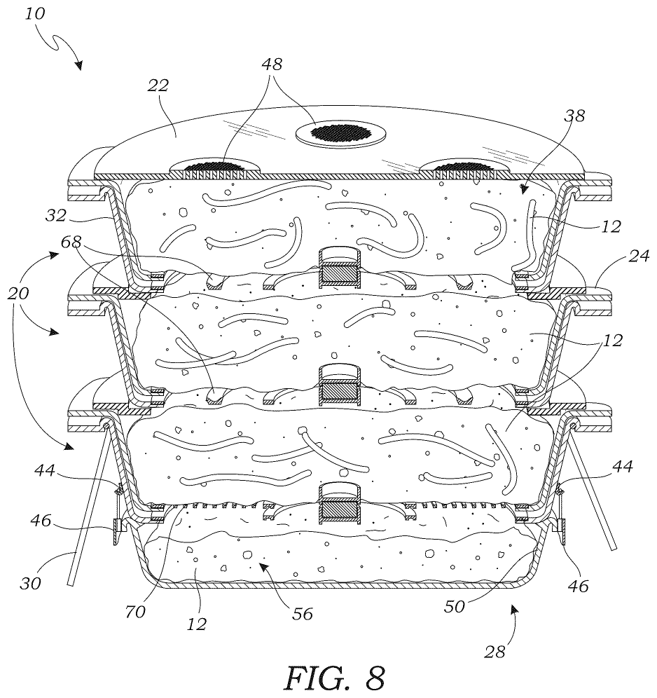

FIG. 8 is a sectional view of the worm compost system taken along line 8-8 in FIG. 1.

### DETAILED DESCRIPTION OF THE INVENTION

The above-described drawing figures illustrate the invention, a worm compost system for processing compostable material through multiple tiers to be caught by a removable harvest tray.

FIG. 1 is a perspective view of a worm compost system 10 according to one embodiment of the present invention. FIG. 2 is a perspective view of a pair of nested working trays 20 having an intermediate stacking ring 24 positioned on top of the pair of working trays 20, and another stacking ring 24 positioned below the pair of working trays 20. As shown in FIGS. 1-2, the worm compost system 10 comprises a plurality of pairs of working trays 20 stacked on top of each other for processing compostable material 12 from top to bottom via worms and a movement mechanism 26, each component being illustrated and discussed in detail below.

As shown in FIG. 1, the worm compost system 10 comprises the top lid 22, the plurality of pairs of working trays 20, the stacking ring 24 positioned between each pair of working trays 20, and a bottom harvest tray 28, wherein the system 10 may be supported by a stand 30. In this embodiment, there are four pairs of working trays 20, however, the number of pairs of working trays 20 may be any suitable number, depending on the nature of the compostable material 12 and the desires of the user.

In various embodiments, each working tray 20 comprises an upwardly extending sidewall 32 that extends upwardly from a base 34 to an upper perimeter 36 to form an internal chamber 38. In some embodiments, each upper perimeter 36 has a flange 40 and handles 42, but in other embodiments, only the inner or outer working tray 20 includes handles 42. In this embodiment, each working tray 20 includes a pair of handles 42 opposite each other on the upper perimeter 36, but any suitable number of handles may be included, in any shape/construction suitable for gripping with a human hand (e.g., loop handles, wire handles, etc.). In some embodiments, the nested working trays 20 may comprise distinct outer and inner trays, i.e., different colors, ornamentation, attachment options, etc., for example, the outer tray may be white to help reflect heat, or similar. However, in other embodiments, the inner and outer trays are identical. The annular sidewall 32 may include mounting slots 44 adjacent the base 34 for receiving fasteners 46 of the harvest tray 28, wherein the mounting slots 44 may be formed only in the outer working tray 20, or in both working trays. The bases 34 of the working trays 20 are best shown in FIGS. 3-6 and described below.

As illustrated in FIGS. 1-2, in this embodiment, the top lid 22 of the system 10 is in the form of a planar body that is sized and adapted to rest on top of the upper perimeter 36 of the topmost working tray 20. In other embodiments, the top lid 22 may be in the form of a dome-shaped body, or any other shape compatible with the function of the present invention. In this embodiment, the perimeter edge includes a plurality of perforated portions 48 formed therethrough, for allowing ventilation, but preventing debris, insects, and extraneous moisture from entering the system 10. While the drawings illustrate four perforated portions 48, another embodiment might include eight perforated portions 48, or any other suitable number.

As illustrated, one of the intermediate stacking rings 24 may be positioned between each pair of working trays 20, to provide support therebetween. In addition, the stacking rings 24 may reduce compression of the compostable material 12 by preventing the working trays 20 from nesting directly on top of each other. In various embodiments, the top lid 22, working trays 20, stacking rings 24, and harvest trays 28 are constructed of HDPE plastic, but any suitable materials (e.g., vinyl, metal, other plastic polymers, etc.) may be used.

As shown in FIG. 1, the harvest tray 28 comprises an upwardly extending annular band 50 that extends to a tray opening, forming an inner receptacle 56. The inner receptacle 56 catches material (worm castings) that falls from the plurality of pairs of working trays 20 for removal. In this embodiment, the harvest tray 28 is shorter in height than the working tray 20, but any suitable dimensions may be implemented. In some embodiments, the harvest tray 28 includes a port 58 located on the annular band 50, the port 58 having a vent plug 60 that allows drainage of any accumulated liquid, provides ventilation, and prevents insects from entering into the harvest tray 28.

In this embodiment, the fastener 46 is in the form of a pair of draw latches that clip into the mounting slots 44 of the bottommost outer working tray 20. The annular band 50 may further include holes (not shown) for securing the fastener 46 to the harvest tray 28, or the fastener 46 may instead be welded, adhered, or co-molded to the harvest tray 28, or attached via a different mechanical means. While the drawings illustrate one possible configuration of the draw latches 46, in other embodiments, they are directly opposite each other. Furthermore, in some embodiments, the latch and the latch bar may be reversed between the working tray 20 and the harvest tray 28. In other embodiments, any form of fastener may be used for removable attachment of the harvest tray 28 and working trays 20, e.g., other types of latches, buckles, release-buttons, switches, hooks, threads, etc.

As shown in FIG. 1, the stand 30 comprises an annular frame body 62 and a plurality of supports 64. In this embodiment, the stand 30 is constructed of stainless steel. In this embodiment, the plurality of supports 64 is in the form of three elongate legs, though any form of support may be used, of any suitable number. In this embodiment, the annular frame 62 is positioned under the flange 40 of the bottommost working tray 20 for supporting the entire worm compost system 10 above a support surface (not shown). The elongate legs 64 may extend a length that is longer than the combined height of the bottommost working tray 20 and the bottom harvest tray 28, and may angle slightly outwardly for a sturdier support base. While three legs are illustrated and described, any suitable number of legs may be included. Furthermore, in some embodiments, the elongate legs 64 may terminate in feet or resilient caps (not shown) or additional support or surface friction.

FIG. 3 is a top perspective view of a working tray 20 showing a first lattice base 68, and FIG. 4 is a top plan view of a pair of nested working trays 20, shown with the first lattice bases 68 in a closed configuration. As shown, each base 68 may be in the form of a lattice/screen that allows air and materials to pass therethrough. In this embodiment, the first lattice base 68 is distinct from a second lattice base 70 which is shown in FIGS. 5-6 and discussed below. In this manner, each pair of working trays 20 may include either the first lattice bases 68 or the second lattice bases 70, for optimizing the transition of compostable material 12 depending on the stage of decomposition. In this embodiment, the top three pairs of working trays 20 include the first lattice base 68, and the bottom pair of working trays 20 includes the second lattice base 70.

In this embodiment, the first lattice base 68 comprises a perimeter ring 72 mounted to the sidewall 32 of the working tray 20, wherein a plurality of ribs 74 extend from the perimeter ring 72 to a center of the base, the plurality of ribs 74 being further connected by a series of arcuate rails 76. The arcuate rails 76 are concentrically aligned with the center, the rails 76 being connected to and perpendicular with the ribs 74. The ribs 74 may be vertically angled to form peaks between each arcuate rail 76. While one example of the ribs 74 is illustrated and described, it should be understood that any form of lattice may be implemented to a similar effect, provided said lattice is within the scope of the invention as claimed. In use, rotation of the inner first lattice base 68 will push the compostable material 12 around within the internal chamber 38, as well as agitating the compostable material 12 to fall downwardly, discussed further below.

In this embodiment, the first lattice base 68 includes two opposing quadrants 78, such that two quarters of the lattice base 68 include only the perimeter ring 72, with no rails 76 or ribs 74, discussed further below.

FIG. 5 is a top plan view of a working tray 20 showing a second lattice base 70, and FIG. 6 is a top plan view of a pair of working trays 20, shown with the second lattice bases 70 in a closed configuration. As shown in FIGS. 5-6, the second lattice base 70 comprises a perimeter ring 73 mounted to the sidewall 32 of the working tray 20, and two opposing quadrants 80 in the form of perforated sheets that extend from the perimeter ring 73. In this embodiment, at least most of the perforations in the second lattice base 70 are smaller than the gaps between the rails 76 and ribs 74 in the first lattice base 68. In this embodiment, the edges of the opposing quadrants 80 are curved, but in other embodiments, any shape of perforated sheet may be implemented, or, as discussed above, alternative forms of lattices.

In some embodiments, the first and/or second lattice bases 68 and 70 may be integrally formed/molded with the working tray 20, or it may be attached after molding.

Due to the segmented nature of the first lattice base 68 and second lattice base 70, the relative rotational position of the inner and outer working trays 20 determine how much open space the lattice bases together allow, thereby affecting how much compostable material 12 will fall into the subsequent pair of working trays 20 or the harvest tray 28. In a fully open configuration, the first lattice base 68 of both the inner and outer working trays 20 are aligned, leaving a similar amount of open space as the single working trays of FIGS. 3 and 5. FIGS. 4 and 6 show fully closed configurations, wherein the quadrants 78, 80 of the outer working tray 20 are positioned beneath the open spaces of the lattice of the inner tray. Put another way, the quadrants 78, 80 are positioned in a “cross” formation. While the Figures illustrate fully open and fully closed configurations, the quadrants 78, 80 may be aligned along any point between the fully open or closed configurations via the movement mechanism 26, the movement mechanism 26 being best shown in FIG. 7 and discussed further below.

FIG. 7 is a bottom perspective view of a set of bearings 82 of the movement mechanism 26 of the working trays 20. As shown in FIG. 7, the set of bearings 82 may be disposed between nested working trays 20, the bearings 82 enabling relative rotational movement of the trays to facilitate passage of compostable material 12 downward through the system 10. In this embodiment, the bearings 82 are positioned within annular ribs or raceways 84 disposed beneath a flange 40 of an inner working tray 20, the bearings 82 configured to contact an upper perimeter 36 of an outer working tray 20 to reduce friction during rotation. As illustrated, in this embodiment, the set of bearings 82 includes at least one bearing housing 86 being adapted to receive a bearing 94. In this embodiment, each bearing housing 86 (holding one bearing 94) may be individually spaced in equal segments around the annular ribs 84. While one embodiment of a set of bearings 82 is illustrated and described, any form of bearing system may be included. For example, in some applications, an elongate member assists with installation of the bearing housing(s) 86

As shown in FIGS. 3-6, the movement mechanism 26 is a combination of the base 34, the handles 42 of the working trays 20, and the set of bearings 82. In use, the handles 42 of the inner working tray 20 are grasped and then rotated such that the quadrants 78, 80 of the first or second lattice bases 68, 70 are moved relative to each other, which causes the compostable material 12 (and potentially some of the worms) to fall through the lattices and into the pair of working trays 20 beneath. In all configurations, the lattice bases 68, 70 support a substantial amount of the compostable material 12, so that the compostable material 12 does not simply fall entirely through upon being added to the topmost working tray 20. In some uses, the open spaces created by the first or second lattice bases 68, 70 may be utilized by adding more compostable material 12 (worm food/bedding).

Furthermore, in some embodiments, material may automatically fall through the lattice without agitation for the following reasons: the material becomes dryer due to ventilation; the worms may break down the material into smaller sized pieces which easily passes through the lattice; and the worms'natural movement through the material agitates the material which passes through the lattice. It is therefore possible that in the right conditions, the worm compost system 10 may automatically “self-harvest,” i.e., produce worm castings in the harvest tray 28 without any agitation. It is also possible that material which has not been fully processed can fall into harvest tray 28. If this occurs and the material is not of a sufficient processed state then the material can be added back into the top working tray 20. By continuously following this procedure, the material will further refine into more processed castings which can eventually be harvested over time.

FIG. 8 is a sectional view of the worm compost system 10 taken along line 8-8 in FIG. 1. As shown in FIG. 8, the topmost pair of working trays 20 may be filled with compostable material 12 and worms by removing and replacing the top lid 22. The compostable material 12 is then processed by the worms, wherein the user may then use the movement mechanism 26 (rotating the handles 42 of the working trays 20) to cause at least some of the compostable material 12 to fall into the pair of working trays 20 or harvest tray 28 beneath. As discussed, the pair of working trays 20 when nested together may be easily rotated against each other, even when there is the weight of material or additional weight of trays placed on top of the given rotating working tray 20. The method makes use of the bearings 82 for smooth rotation of the working trays 20.

Each level of working trays 20 results in a more processed compostable material 12. Depending on the desired result, a greater or fewer number of pairs of working trays 20 may be installed than is shown and described herein. As illustrated, the harvest tray 28 may be attached to the bottommost pair of working trays 20 via the fastener 46 and the mounting slots 44. The harvest tray 28 catches the result of the processing of compostable material 12, and acts as a sump to collect excess liquid (leachate) from the system 10.

In this embodiment, the harvest tray 28 is easily removed from the rest of the worm compost system 10, without having to dismantle other components. The stand 30 supports the system 10 beneath the flange 40 of the bottommost working tray 20, suspending the harvest tray 28 above the support surface for easy removal.

The combination of the port 58 of the harvest tray 28 and the perforated portions 48 of the lid cover 22 allows ventilation from top to bottom. The rotation of the trays facilitates the downward movement of material, reducing large air gaps that typically occur between trays in prior art systems. As the material settles, it forms a contiguous body between trays, allowing worms to migrate freely without restriction. In addition the entire system 10 is constructed with low-cost materials that are easy to manufacture and assemble, making it more efficient and accessible than many prior art systems, while still maintaining enhanced functionality.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A worm compost system comprising:
a plurality of pairs of working trays, each working tray including an upwardly extending sidewall extending from a base to an upper perimeter to form an internal chamber;
a lid assembly positioned on a topmost pair of the working trays;
a harvest tray removably attachable beneath a bottommost pair of the working trays, the harvest tray configured to collect processed compostable material; and
a movement mechanism including a set of bearings disposed between nested trays of each pair of working trays, the bearings enabling relative rotational movement of the trays to facilitate passage of compostable material downward through the system.

2. The worm compost system of claim 1, wherein at least some of the working trays include handles disposed on the upper perimeter for rotating an inner tray relative to an outer tray of the pair.

3. The worm compost system of claim 1, wherein each base comprises a lattice configured to obstruct and support compostable material until agitation causes passage of material through the lattice.

4. The worm compost system of claim 1, wherein each working tray includes either a first base having a first lattice, or a second base having a second lattice.

5. The worm compost system of claim 1, wherein the bearings are positioned within annular ribs or raceways disposed beneath a flange of an inner working tray, the bearings configured to contact an upper perimeter of an outer working tray to reduce friction during rotation.

6. The worm compost system of claim 1, wherein the harvest tray comprises an annular band extending upwardly from a planar sheet to define a receptacle configured to collect worm castings.

7. The worm compost system of claim 1, wherein the harvest tray includes a fastener removably engaging mounting slots formed in the bottommost working tray.

8. The worm compost system of claim 7, wherein the fastener comprises a pair of draw latches.

9. The worm compost system of claim 1, further comprising a stand including an annular frame body and a plurality of supports configured to suspend the worm compost system above a support surface.

10. The worm compost system of claim 1, wherein the top lid is in the form of a perforated lid cover positionable over the central opening.

11. The worm compost system of claim 1, further comprising an intermediate stacking ring positioned between each pair of working trays.

12. The worm compost system of claim 1, wherein the system is constructed of high-density polyethylene (HDPE) plastic.

13. The worm compost system of claim 1, wherein each working tray includes a first lattice base.

14. A method of operating the worm compost system of claim 1, comprising:
introducing compostable material and worms into the topmost pair of working trays;
permitting worms to process the compostable material within the trays; and
rotating an inner tray relative to an outer tray on the bearings to cause at least some of the compostable material to pass downward through the system into the harvest tray.

15. A worm compost system comprising:
a plurality of stacked tray assemblies, each tray assembly including an inner tray and an outer tray, the inner tray being rotatable relative to the outer tray about a generally vertical axis;
each tray having a perforated or lattice base such that relative rotation changes alignment of openings to control passage of compostable material;
a low-friction rotational interface disposed between the trays, the interface including bearings, rollers, bushings, or equivalent structures;
a lid covering an uppermost tray assembly; and
a harvest receptacle positioned below a lowermost tray assembly to collect castings and leachate.
